(19) United States
(12) Patent Application Publication
(10) Pub. No.: US 2024/0290565 A1
(43) Pub. Date: Aug. 29, 2024

(54) EXPLOSION-PROOF OVER-CURRENT PROTECTION ELEMENT AND MANUFACTURING METHOD THEREOF

(71) Applicants: Yageo Electronics (China)Co., LTD, Jiangsu Province (CN); BESTBRIGHT ELECTRONICS CO., LTD., Guangdong Province (CN)

(72) Inventors: Tzu Yueh CHANG, Jiangsu Province (CN); Weiwei ZHAO, Jiangsu Province (CN)

(21) Appl. No.: 18/304,364

(22) Filed: Apr. 21, 2023

(30) Foreign Application Priority Data
Feb. 24, 2023 (CN) 202310162721.1

(51) Int. Cl. H01H 85/00; H01H 69/02; H01H 85/17; H01H 85/18; H01H 85/34; H01H 85/38

(52) U.S. Cl. CPC H01H 85/0082; H01H 69/02; H01H 85/17; H01H 85/18; H01H 85/34; H01H 85/38; H01H 2085/388

(57) ABSTRACT

An explosion-proof over-current protection element includes a fuse body, a ceramic shell, an explosion-proof layer, an arc-extinguishing layer, and a protection layer. The fuse body includes two electrodes and a fuse wire between the electrodes. The fuse body is integrally formed. The fuse wire is arranged within a cavity of the ceramic shell. The electrodes protrude from inside of the cavity toward outside of the cavity to contact an outer wall of the ceramic shell. The explosion-proof layer is arranged within the cavity and contacts a bottom surface of the cavity. The arc-extinguishing layer is arranged within the cavity and covers the fuse wire. The explosion-proof layer and the arc-extinguishing layer are made of different materials. The protection layer is arranged within the cavity. The arc-extinguishing layer is located between the explosion-proof layer and the protection layer.

### RELATED APPLICATIONS

This application claims priority to Chinese Application Serial Number 202310162721.1, filed Feb. 24, 2023, the disclosures of which are incorporated herein by reference in their entireties.

### BACKGROUND

### Field of Invention

The present invention relates to an over-current protection element. More particularly, the present invention relates to an explosion-proof over-current protection element and manufacturing method thereof.

### Description of Related Art

During the breaking test, the known fuses often have problems such as bursting and splashing of the main body, etc. The main reason of those problems is that the fuse does not have a good pressure dispersion/buffer structure. The known fuse structure may be classified into three groups. The first group relates to a structure of wire in air. Such structure has problems that the pressure cannot be effectively buffered when the fuse body is gasified, and when the pressure acts on the outer shell, it is easy to cause the outer shell to burst and splash. The second group is that the polymer material is filled within the outer shell. The arc generated by such structure, during the breaking test, will be in contact with the polymer material, and the high temperature generated by the arc will carbonize the polymer material, and thus the pressure within the outer shell is increased, thereby causing the outer shell to peel off from the polymer material. The third group is that the arc-extinguishing material is filled within the outer shell. Such structure has an effective arc-extinguishing effect, but does not have the function of preventing the main body of the outer shell from bursting. The known fuse structures, for example, may refer to the following published or granted patents No.: CN109661712B, U.S. Pat. No. 5,648,750A, TWI505314B, CN104103463A, JP2021089832A, TWI709991B, CN204088237U, CN211605079U, CN212848287U, and CN213150709U.

The granted patent No. CN104137217B provides a chip-type fuse with integrally formed fuse and terminals which can be manufactured with ease. It improves the structure through structural design so that it can easily manufacture chip-type fuses. However, it also does not have the function of preventing the main body of outer shell from bursting. Therefore, in order to overcome the disadvantages and deficiencies in the prior art, it is necessary for the present invention to provide an improved overcurrent protection element with an explosion-proof function, so as to solve the problems in the above-mentioned conventional technology.

### SUMMARY

The present invention provides an explosion-proof over-current protection element includes a fuse body, a ceramic shell, an explosion-proof layer, an arc-extinguishing layer, and a protection layer. The fuse body includes two electrodes and a fuse wire between the electrodes. The fuse body is integrally formed. The fuse wire is arranged within a cavity of the ceramic shell. The electrodes protrude from inside of the cavity toward outside of the cavity to contact an outer wall of the ceramic shell. The explosion-proof layer is arranged within the cavity and contacts a bottom surface of the cavity. The arc-extinguishing layer is arranged within the cavity and covers the fuse wire. The explosion-proof layer and the arc-extinguishing layer are made of different materials. The protection layer is arranged within the cavity. The arc-extinguishing layer is located between the explosion-proof layer and the protection layer.

In accordance with one or more embodiments of the invention, a volume of the explosion-proof layer is less than a quarter of a volume of the cavity.

In accordance with one or more embodiments of the invention, the arc-extinguishing layer contacts the explosion-proof layer. The protection layer contacts the arc-extinguishing layer. The explosion-proof layer and the protection layer are made of polymer silicone.

In accordance with one or more embodiments of the invention, a material of the arc-extinguishing layer is selected from quartz, silicone, melamine, glass, or a combination thereof.

In accordance with one or more embodiments of the invention, the arc-extinguishing layer has a powder structure.

In accordance with one or more embodiments of the invention, the arc-extinguishing layer has a sand structure and a particle size mesh selected for sand filling is between 10 and 600 mesh.

In accordance with one or more embodiments of the invention, each of the electrodes protrudes from inside of the cavity toward outside of the cavity and contacts an end of the ceramic shell to form a sloped electrode, wherein the sloped electrode is connected with the fuse wire, wherein each of the electrodes protruded out of the cavity is bent towards the end of the ceramic shell to form a planar electrode. The sloped electrode is connected with the planar electrode. There is a gap between the planar electrode and the end of the ceramic shell for silicone filling.

The present invention provides a manufacturing method of an explosion-proof over-current protection element includes: providing a ceramic shell having a cavity; filling an explosion-proof layer within the cavity, such that the explosion-proof layer is arranged within the cavity and contacts a bottom surface of the cavity; providing a fuse body including two electrodes and a fuse wire between the electrodes, in which the fuse wire and the electrodes are integrally formed; combining the fuse body and the ceramic shell, such that the fuse wire is arranged within the cavity and the electrodes protrude from inside of the cavity toward outside of the cavity to contact an outer wall of the ceramic shell; filling an arc-extinguishing layer within the cavity, such that the arc-extinguishing layer covers the fuse wire, in which the explosion-proof layer and the arc-extinguishing layer are made of different materials; and filling a protection layer within the cavity, such that the arc-extinguishing layer is located between the explosion-proof layer and the protection layer.

In accordance with one or more embodiments of the invention, the manufacturing method further includes: forming the arc-extinguishing layer by filling sand. A particle size mesh selected for sand filling is between 10 and 600 mesh.

In accordance with one or more embodiments of the invention, the manufacturing method further includes: forming a character code on the ceramic shell by printing. The character code corresponds to rated current information.

In accordance with one or more embodiments of the invention, a volume of the explosion-proof layer is less than a quarter of a volume of the cavity.

In accordance with one or more embodiments of the invention, the arc-extinguishing layer contacts the explosion-proof layer. The protection layer contacts the arc-extinguishing layer. The explosion-proof layer and the protection layer are made of polymer silicone.

In accordance with one or more embodiments of the invention, a material of the arc-extinguishing layer is selected from quartz, silicone, melamine, glass, or a combination thereof.

In accordance with one or more embodiments of the invention, the arc-extinguishing layer has a powder structure.

In accordance with one or more embodiments of the invention, each of the electrodes protrudes from inside of the cavity toward outside of the cavity and contacts an end of the ceramic shell to form a sloped electrode, wherein the sloped electrode is connected with the fuse wire, wherein each of the electrodes protruded out of the cavity is bent towards the end of the ceramic shell to form a planar electrode. The sloped electrode is connected with the planar electrode. There is a gap between the planar electrode and the end of the ceramic shell for silicone filling.

In order to let above mention of the present invention and other objects, features, advantages, and embodiments of the present invention to be more easily understood, the description of the accompanying drawing as follows.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a longitudinal sectional side view of an explosion-proof over-current protection element according to some embodiments of the present invention.

FIG. 2 illustrates a longitudinal sectional side view of a fuse body according to some embodiments of the present invention.

FIG. 3 illustrates a diagram showing an actual effect of a character code according to some embodiments of the present invention.

FIG. 4 illustrates a longitudinal sectional side view of an explosion-proof over-current protection element according to some embodiments of the present invention.

FIG. 5 illustrates a longitudinal sectional side view of an explosion-proof over-current protection element according to some embodiments of the present invention.

FIG. 6 illustrates a flowchart of a manufacturing method of an explosion-proof over-current protection element according to some embodiments of the present invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation.

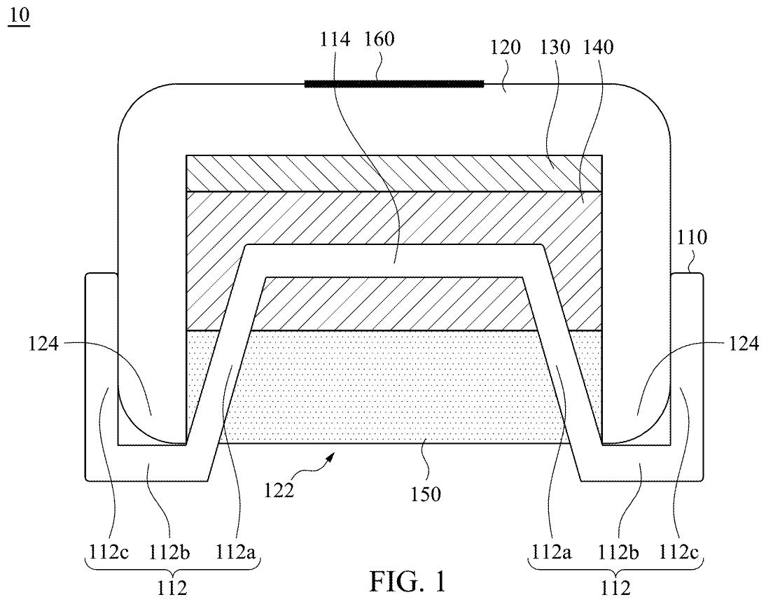

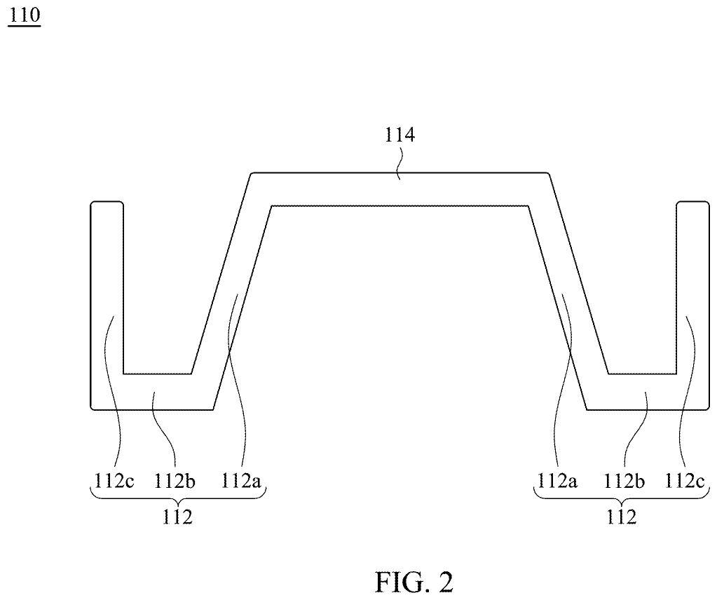

FIG. 1 illustrates a longitudinal sectional side view of an explosion-proof over-current protection element 10 according to some embodiments of the present invention. The explosion-proof over-current protection element 10 includes a fuse body 110, a ceramic shell 120, an explosion-proof layer 130, an arc-extinguishing layer 140, and a protection layer 150. FIG. 2 illustrates a longitudinal sectional side view of the fuse body 110 according to some embodiments of the present invention.

As shown in FIG. 1 and FIG. 2, the fuse body 110 includes two electrodes 112 and a fuse wire 114 between the electrodes 112. The fuse body 110 may be manufactured by stamping a conductive metal sheet. In other words, the fuse body 110 is integrally formed, such that two ends of the fuse wire 114 are respectively connected to the electrodes 112. The fuse body 110 may be formed by any suitable conductive material such as, but not limited to, copper, copper alloys, silver, silver alloys, tin, nickel, zinc, etc. The fuse body 110 is a symmetrical metal material, which has a good heat transfer effect.

As shown in FIG. 1 and FIG. 2, the ceramic shell 120 is a box-shaped member having a downward opening, and thus the ceramic shell 120 has a cavity 122. The fuse wire 114 is arranged within the cavity 122 of the ceramic shell 120. The electrodes 112 extend from its connection with the fuse wire 114 and protrude from inside of the cavity 122 toward outside of the cavity 122 to contact an outer wall of the ceramic shell 120.

In detail, the electrodes 112 protrude from inside of the cavity 122 toward outside of the cavity 122 and contact an end 124 of the ceramic shell 120 to respectively form two sloped electrodes 112a. The sloped electrodes 112a are connected to the fuse wire 114. In addition, the electrodes 112 protruded out of the cavity 122 are bent towards the end 124 of the ceramic shell 120 to respectively form two planar electrodes 112b. The planar electrodes 112b are parallel to a bottom surface of the cavity 122 and also parallel to the fuse wire 114. The sloped electrodes 112a are respectively connected with the planar electrodes 112b. Finally, the electrodes 112 bent toward the ends 124 of the ceramic shell 120 are further bent toward the outer wall of the ceramic shell 120 by 90 degrees to respectively form two standing electrodes 112c. The standing electrodes 112c are respectively connected to the planar electrodes 112b.

As shown in FIG. 1, the explosion-proof layer 130 is arranged within the cavity 122 and contacts the bottom surface of the cavity 122. The bottom surface of the cavity 122 is opposite to the downward opening of the ceramic shell 120. Specifically, the explosion-proof layer 130 is closely combined with the bottom surface of the cavity 122. In some embodiment, the explosion-proof layer 130 is made of polymer silicone. The explosion-proof layer 130 can slow down the internal pressure of gas generated when the fuse body gasifies during breaking to avoid damage to the ceramic shell 120.

As shown in FIG. 1, the arc-extinguishing layer 140 is arranged within the cavity 122. The arc-extinguishing layer 140 is made of an arc extinguishing material, which can suppress arc generation (the arc will cause the product to burst) and thus has an arc extinguishing effect. As shown in FIG. 1 and FIG. 2, the arc-extinguishing layer 140 covers the fuse wire 114 and partially covers the electrodes 112. Specifically, the arc-extinguishing layer 140 surrounds and covers the fuse wire 114, and the arc-extinguishing layer 140 covers four surfaces of the fuse wire 114.

In some embodiments, arc-extinguishing layer 140 is made of the arc extinguishing material, and the arc extinguishing material may, for example, be selected from quartz, silicone, melamine, glass, or a combination thereof, but the present disclosure is not limited thereto. In some embodiments, the arc-extinguishing layer 140 has a powder structure or a sand structure. In other words, the explosion-proof layer 130 and the arc-extinguishing layer 140 are made of different materials. For example, the arc-extinguishing layer 140 is made of quartz sand. In addition, when the arc-extinguishing layer 140 has a sand structure, the particle size mesh selected for sand filling is between 10 and 600 mesh, and preferably, the particle size mesh selected for sand filling is between 80 and 100 mesh. Specifically, the particle size mesh selected for sand filling may control the fusing performance and the breaking performance.

In some embodiments, the volume of the explosion-proof layer 130 is less than a quarter of the volume of the cavity 122. The reason of the aforementioned volume difference is that if the volume of the explosion-proof layer 130 is too large, the volume of the arc-extinguishing layer 140 will be correspondingly reduced, thereby affecting the arc-extinguishing effect of the arc-extinguishing layer 140. Therefore, the purpose of the aforementioned volume difference is to maintain the enough arc-extinguishing effect of the arc-extinguishing layer 140.

As shown in FIG. 1, the protection layer 150 is arranged within the cavity 122. The arc-extinguishing layer 140 is located between the explosion-proof layer 130 and the protection layer 150. Specifically, the arc-extinguishing layer 140 contacts the explosion-proof layer 130 and is closely combined with the explosion-proof layer 130. The protection layer 150 contacts the arc-extinguishing layer 140 and is closely combined with the arc-extinguishing layer 140. In other words, the explosion-proof layer 130, the arc-extinguishing layer 140 and the protection layer 150 are all disposed within the cavity 122 of the ceramic shell 120. The explosion-proof layer 130, the arc-extinguishing layer 140 and the protection layer 150 are sequentially stacked from the bottom surface of the cavity 122 of the ceramic shell 120 to the opening of the ceramic shell 120, thereby forming a stacked structure, and thus the protection layer 150 seals the opening of the ceramic shell 120.

In some embodiments, the protection layer 150 is made of polymer silicone. The protection layer 150 has the functions of explosion-proof, buffering, sealing, etc. The protection layer 150 may prevent moisture from entering the interior of the disclosed structure.

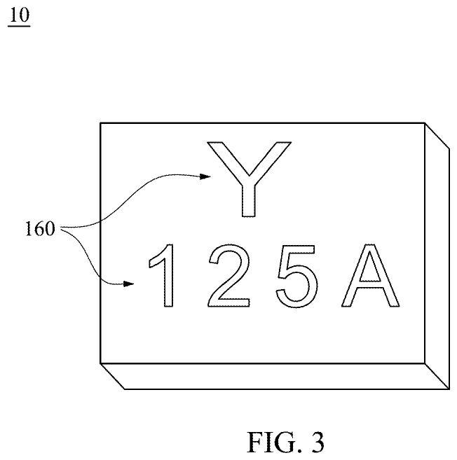

As shown in FIG. 1, the explosion-proof over-current protection element 10 further includes a character code 160. FIG. 3 illustrates a diagram showing an actual effect of the character code 160 according to the embodiments of the present invention. The character code 160 is formed on the outer wall of the ceramic shell 120 by printing, such as laser printing, planographic printing, planographic printing lithography, offset printing, screen printing, relief printing, heat transfer printing, gravure printing, transfer tape, ribbon, inkjet, dye transfer, etc. . . . The character code 160 corresponds to rated current information of the explosion-proof over-current protection element 10.

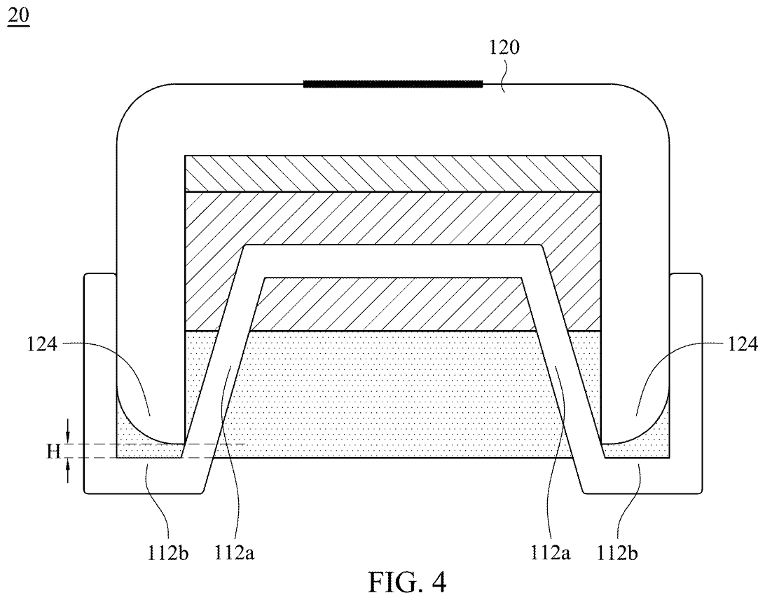

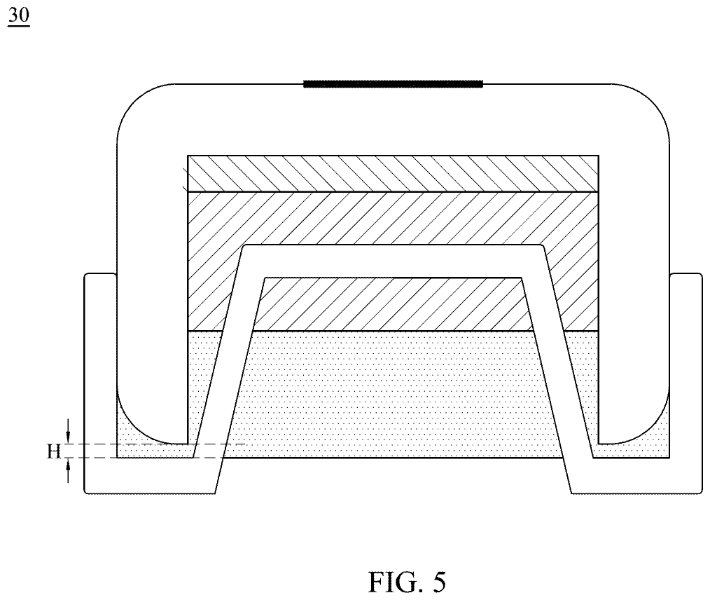

FIG. 4 illustrates a longitudinal sectional side view of an explosion-proof over-current protection element 20 according to some embodiments of the present invention. FIG. 5 illustrates a longitudinal sectional side view of an explosion-proof over-current protection element 30 according to some embodiments of the present invention. FIG. 4 is similar to FIG. 1 and FIG. 5 is similar to FIG. 1. The difference between the explosion-proof over-current protection element 20 and the explosion-proof over-current protection element 10 and the between the explosion-proof over-current protection element 30 and the explosion-proof over-current protection element 10 are that there is a gap H between the planar electrode 112b of each of the explosion-proof over-current protection element 20 and the explosion-proof over-current protection element 30 and the end 124 of the ceramic shell 120 for silicone filling. The distance H can effectively increase the filling amount of silicone (polymer silicone), thereby achieving better bonding strength. The way to form the distance H can be, for example, increasing the length of the sloped electrode 112a (as shown in FIG. 4) or adjusting the angle between the sloped electrode 112a and the planar electrode 112b (as shown in FIG. 5). In other words, the angle or length of the sloped electrode 112a can be changed so that there is a distance H between the planar electrode 112b and the end 124 of the ceramic shell 120 for silicone filling. Furthermore, in other embodiments, the electrode 112 of the fuse body 110 may not be in contact with the peripheral wall of the ceramic shell 120 (including the inner wall, the end and the outer wall of the ceramic shell 120), but the above-mentioned distance H makes silicone interposed between the ceramic shell 120 and the electrodes 112 of the fuse body 110.

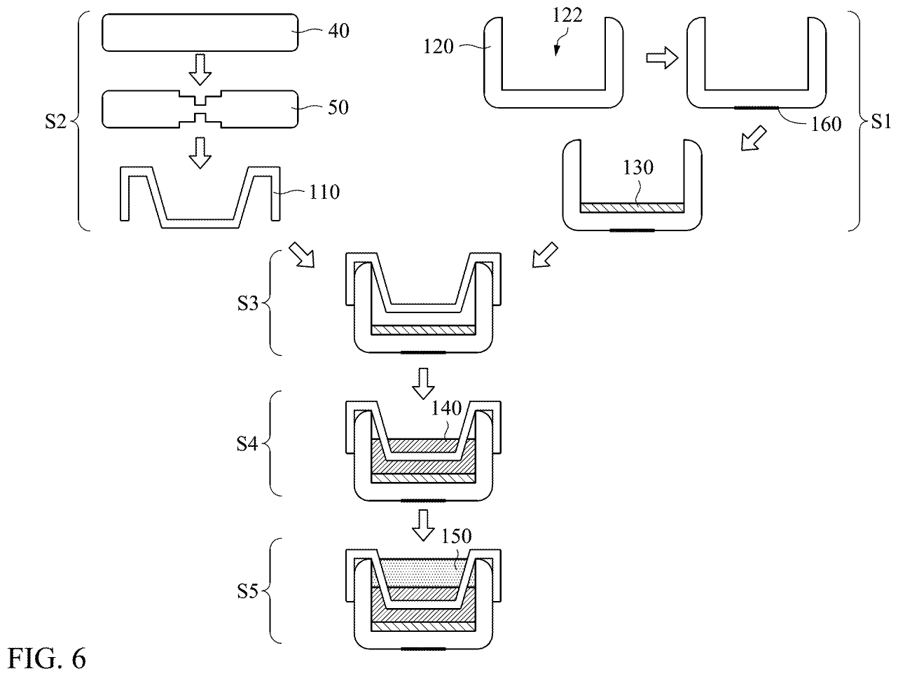

FIG. 6 illustrates a flowchart of a manufacturing method of the explosion-proof over-current protection element 10 according to some embodiments of the present invention. First, the ceramic shell 120 is provided (i.e., the step S1), and in parallel therewith, the fuse body 110 is provided (i.e., the step S2). In step S1, the ceramic shell 120 has the cavity 122. In step S1, the character code 160 corresponding to the rated current information is formed on the outer wall of the ceramic shell 120 by printing. Then, in step S1, the explosion-proof layer 130 is filled within the cavity 122 by dispensing (polymer silicone), so that the explosion-proof layer 130 is disposed within the cavity 122 and contacts the bottom surface of the cavity 122. On the other hand, in the step S2, sheet shaping is performed on the conductive metal sheet 40 to provide the unbent fuse body 50. For example, the conductive metal sheet 40 is tin-immersed copper strip, but the present disclosure is not limited thereto. For example, the sheet shaping method for the conductive metal sheet 40 may be laser cutting, lithography etching, wire cutting, etc. Then, the unbent fuse body 50 is bent and shaped by stamping, thereby forming the fuse body 110. The unbent fuse body 50 is formed as a sheet with the narrowest (and/or thinnest) middle portion and the widest (and/or thickest) end portions, such that the fuse wire 114 of the fuse body 110 has a smaller conductive area/volume than the two electrodes 112 of the fuse body 110, and thereby, the fuse wire 114 actives on overcurrent more quickly.

Then, in step S3, the fuse body 110 and the ceramic shell 120 are combined, such that the fuse wire 114 of the fuse body 110 is arranged within the cavity 122.

Then, in step S4, the arc-extinguishing layer 140 is formed by filling sand, such that the arc-extinguishing layer 140 is formed within the cavity 122, so that the arc-extinguishing layer 140 covers the fuse wire 114 of the fuse body 110.

Finally, in step S5, the protection layer 150 is filled within the cavity 122 by dispensing (polymer silicone), so that the arc-extinguishing layer 140 is located between the explosion-proof layer 130 and the protection layer 150. It should be noted that the final assembled product of the explosion-proof over-current protection element shown in step S5 of FIG. 6 is reversely disposed, and the practical positive disposed finished product is shown in FIG. 1. In other words, the final assembled product shown in step S5 of FIG. 6 must be turned vertically into a positive disposed finished product before it can be used as a finished product.

From the above description, the present disclosure provides an explosion-proof over-current protection element. The present disclosure re-designs the structure based on the shortcomings of the conventional technology. The main structural design concept of the present disclosure is to form a stacked structure within the cavity of the ceramic shell of the fuse component. This structure has the functions of explosion-proof (i.e., the explosion-proof layer), arc-extinguishing (i.e., the arc-extinguishing layer), and protection (i.e., the protection layer), thereby effectively suppressing the arc during breaking and slowing down the internal pressure generated when the fuse body gasifies, thereby avoiding damage to the ceramic shell of the fuse component.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An explosion-proof over-current protection element, comprising:
a fuse body including two electrodes and a fuse wire between the electrodes, wherein the fuse body is integrally formed;
a ceramic shell, wherein the fuse wire is arranged within a cavity of the ceramic shell, wherein the electrodes protrude from inside of the cavity toward outside of the cavity to contact an outer wall of the ceramic shell;
an explosion-proof layer arranged within the cavity and contacting a bottom surface of the cavity;
an arc-extinguishing layer arranged within the cavity and covering the fuse wire, wherein the explosion-proof layer and the arc-extinguishing layer are made of different materials; and
a protection layer arranged within the cavity, wherein the arc-extinguishing layer is located between the explosion-proof layer and the protection layer.

2. The explosion-proof over-current protection element of claim 1, wherein a volume of the explosion-proof layer is less than a quarter of a volume of the cavity.

3. The explosion-proof over-current protection element of claim 1, wherein the arc-extinguishing layer contacts the explosion-proof layer, wherein the protection layer contacts the arc-extinguishing layer, wherein the explosion-proof layer and the protection layer are made of polymer silicone.

4. The explosion-proof over-current protection element of claim 1, wherein a material of the arc-extinguishing layer is selected from quartz, silicone, melamine, glass, or a combination thereof.

5. The explosion-proof over-current protection element of claim 1, wherein the arc-extinguishing layer has a powder structure.

6. The explosion-proof over-current protection element of claim 1, wherein the arc-extinguishing layer has a sand structure and a particle size mesh selected for sand filling is between 10 and 600 mesh.

7. The explosion-proof over-current protection element of claim 1, wherein each of the electrodes protrudes from inside of the cavity toward outside of the cavity and contacts an end of the ceramic shell to form a sloped electrode, wherein the sloped electrode is connected with the fuse wire, wherein each of the electrodes protruded out of the cavity is bent towards the end of the ceramic shell to form a planar electrode, wherein the sloped electrode is connected with the planar electrode, wherein there is a gap between the planar electrode and the end of the ceramic shell for silicone filling.

8. A manufacturing method of an explosion-proof over-current protection element, comprising:
providing a ceramic shell, wherein the ceramic shell has a cavity;
filling an explosion-proof layer within the cavity, such that the explosion-proof layer is arranged within the cavity and contacts a bottom surface of the cavity;
providing a fuse body, wherein the fuse body includes two electrodes and a fuse wire between the electrodes, wherein the fuse wire and the electrodes are integrally formed;
combining the fuse body and the ceramic shell, such that the fuse wire is arranged within the cavity and the electrodes protrude from inside of the cavity toward outside of the cavity to contact an outer wall of the ceramic shell;
filling an arc-extinguishing layer within the cavity, such that the arc-extinguishing layer covers the fuse wire, wherein the explosion-proof layer and the arc-extinguishing layer are made of different materials; and
filling a protection layer within the cavity, such that the arc-extinguishing layer is located between the explosion-proof layer and the protection layer.

9. The manufacturing method of claim 8, further comprising:
forming the arc-extinguishing layer by filling sand, wherein a particle size mesh selected for sand filling is between 10 and 600 mesh.

10. The manufacturing method of claim 8, further comprising:
forming a character code on the ceramic shell by printing, wherein the character code corresponds to rated current information.

11. The manufacturing method of claim 8, wherein a volume of the explosion-proof layer is less than a quarter of a volume of the cavity.

12. The manufacturing method of claim 8, wherein the arc-extinguishing layer contacts the explosion-proof layer, wherein the protection layer contacts the arc-extinguishing layer, wherein the explosion-proof layer and the protection layer are made of polymer silicone.

13. The manufacturing method of claim 8, wherein a material of the arc-extinguishing layer is selected from quartz, silicone, melamine, glass, or a combination thereof.

14. The manufacturing method of claim 8, wherein the arc-extinguishing layer has a powder structure.

15. The manufacturing method of claim 8, wherein each of the electrodes protrudes from inside of the cavity toward outside of the cavity and contacts an end of the ceramic shell to form a sloped electrode, wherein the sloped electrode is connected with the fuse wire, wherein each of the electrodes protruded out of the cavity is bent towards the end of the ceramic shell to form a planar electrode, wherein the sloped electrode is connected with the planar electrode, wherein there is a gap between the planar electrode and the end of the ceramic shell for silicone filling.
